(19) United States
(12) Patent Application Publication
(10) Pub. No.: US 2015/0279270 A1
(43) Pub. Date: Oct. 1, 2015

(54) WEARABLE BAND INCLUDING DUAL FLEXIBLE DISPLAYS

(71) Applicant: Christopher Sterling, Oklahoma City, OK (US)

(72) Inventor: Christopher Sterling, Oklahoma City, OK (US)

(21) Appl. No.: 14/671,799

(22) Filed: Mar. 27, 2015

Related U.S. Application Data
(60) Provisional application No. 61/971,175, filed on Mar. 27, 2014.

(51) Int. Cl. G09G 3/32; G06F 3/041; G06F 1/16

(52) U.S. Cl. CPC G09G 3/3208; G06F 1/163; G06F 3/0412; G06F 1/1686; G06F 2203/04101; G06F 2200/1612

(57) ABSTRACT

According to a first aspect, there is provided herein a dual-display video device. In an embodiment, a bracelet, will be configured with two video displays—one that is oriented to be viewable when worn and a second oriented to be next to the wearer's skin when worn or displayable as a second video display when not worn.

### CROSS REFERENCE TO RELATED APPLICATION

This application claims the benefit of U.S. Provisional Application No. 61/971,175 filed Mar. 27, 2014, herein incorporated by reference in its entirety for all purposes.

### FIELD OF THE INVENTION

This invention relates, in general, to flexible displays and, in particular, to wearable flexible displays that can be wrapped around a body or an appendage thereof.

### BACKGROUND

Without limiting the scope of the present invention, its background will be described with reference to flexible displays that are suitable for presenting computerized information such as text, video, etc. With the increasing availability of displays that can be bent into ever increasing degrees of curvature it has become possible to incorporate such displays into consumer and other products that would have been impossible even a few years ago.

Further, there is a clear trend that is moving the consuming public toward wearable electronics that monitor exercise levels (steps, calories, distance, altitude changes) and biometric variables (e.g., heart rate, temperature, etc.). Computerized wearables from manufactures such as Fitbit®, HTC®, are readily available and popularly utilized.

That being said, a problem with current devices of this type is that they have limited displays. Often such displays are only capable of showing minimal text information and crude graphics. Clearly, a wearable that provided better capabilities in this regard would be a welcomed addition to this product category.

Heretofore, as is well known in the computer display arts there has been a need for an invention to address and solve the disadvantages of prior art devices. Accordingly it should now be recognized, as was recognized by the present inventor, that there exists, and has existed for some time, a very real need for a system that would address and solve the above-described shortcoming of the prior art.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY OF THE INVENTION

According to a first aspect, there is provided herein a dual-display wearable video device. In an embodiment, a bracelet will be configured with two video displays—one that has an upper surface that can be viewed when worn and a second oriented to be next to the wearer's skin when worn or displayable as a second video display when not worn. More particularly, in an embodiment an uppermost display screen will be visible continuously when worn as a bracelet. Information that appears on that screen might be displayed or scrolled around it either continuously or intermittently under control of the user. The functionality of the display surface will be controlled by a control panel that contains a microprocessor therein. Additional aspects of the invention could include wireless communication, detachable and removable devices such as cameras, etc.

Other embodiments might include belts, headbands, etc., wherein the belt, headband, etc., is a wearable display device with both an upper and lower (or inside and outside, etc.) display. The display surface will comprise two bendable displays and, more particularly, two displays that can be bent into a closed circle. In an embodiment, the length will be adjustable by overlapping the display surface, thereby shortening it or lengthening it as needed.

Taught herein is a dual screen device, comprising: a control panel, said control panel containing a microprocessor therein, said microprocessor being positionable to be in electronic communication with a remote computer and to receive information therefrom: a flexible band attachable to said control panel, said flexible band having an inner surface and an outer surface, said flexible band being bendable to form a closed circle, wherein said inner surface comprises a first flexible display and said outer surface comprise a second flexible display, wherein said first and second flexible displays are in electronic communication with said microprocessor and capable of displaying information received by the microprocessor thereon.

Also taught herein is a wearable dual screen device, comprising: a control panel, said control panel containing a microprocessor therein, said microprocessor being positionable to be in electronic communication with a remote computer and to receive information therefrom; a first flexible display having a first display outer surface and a first display inner surface, said first display being in electronic communication with said microprocessor and being adaptable to display on said first display outer surface said information therefrom, wherein said first display is bendable to form a closed circle and sized to be wearable by a user; a second flexible display having a second display surface, said second display being in electronic communication with said microprocessor and being adaptable to display said information therefrom, said second display is bendable to form a closed circle and sized to be wearable by a user, wherein said first and second flexible display are incorporated into said wearable duel screen device such that said first display outer surface and said second display outer surface are both visible when said dual screen device is not worn.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 illustrates a cross sectional view of an embodiment.

FIG. 2 contains a detailed view of a cross sectional view of an embodiment which contains an example of certain control features.

FIG. 3 contains a plan view of the embodiment of FIG. 1.

FIG. 4 contains details of another embodiment that includes a USB port.

FIG. 5 contains a top-down view of an embodiment.

FIGS. 6A and 6B illustrate two different latch mechanisms suitable for use with embodiments of the invention.

FIG. 7 contains additional details of control and other features of an embodiment.

FIG. 8 illustrates further details of an embodiment.

FIG. 9 contains a schematic illustration of a control panel.

FIG. 10 contains a 2-camera embodiment.

FIG. 11 contains a hardware schematic of an embodiment.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

According to an embodiment there is provided a wearable dual screen/two sided bendable computer display and associated microprocessor that can be affixed around an object such as a user's arm, leg, waist, etc., by way of example only. The dual screen display must be flexible enough to form a closed circle as is illustrated in, for example, in FIG. 6A. In other embodiments, the band might be long enough to reach around larger objects such as a tree, an appliance, an auto, etc. Generally speaking, the instant invention will accommodate arbitrarily large or small devices built according to the instant invention.

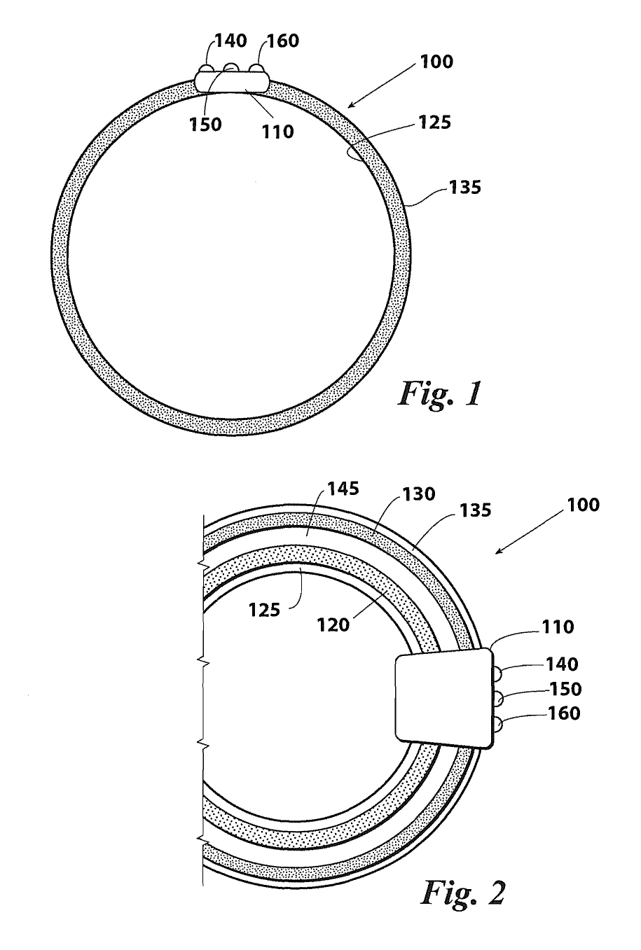

According to an embodiment (FIG. 1) there is provided a dual-sided wearable bendable display device 100 for use with a remote computer. The band 100 can be of any size (e.g., it might be a bracelet, a headband, a neck band, a belt, etc.) and will contain displays on both its inner 125 and outer 135 surfaces. In some embodiments the displays might be OLED, LED, or any display technology that is suitable for presenting text and/or graphics to a user and which can be flexibly formed into a complete circle. Flexible OLED displays that would be suitable for use with embodiments of the invention are made by, for example, LG®, and Samsung®. As an example, LGD's flexible OLED display is built on a plastic substrate and it uses “film-type” encapsulation technology, encapsulation being necessary to protect the display from exposure to water vapor and oxygen. The currently available flexible panel is unbreakable and bendable and can bend vertically from top to bottom with a radius of 700 mm.

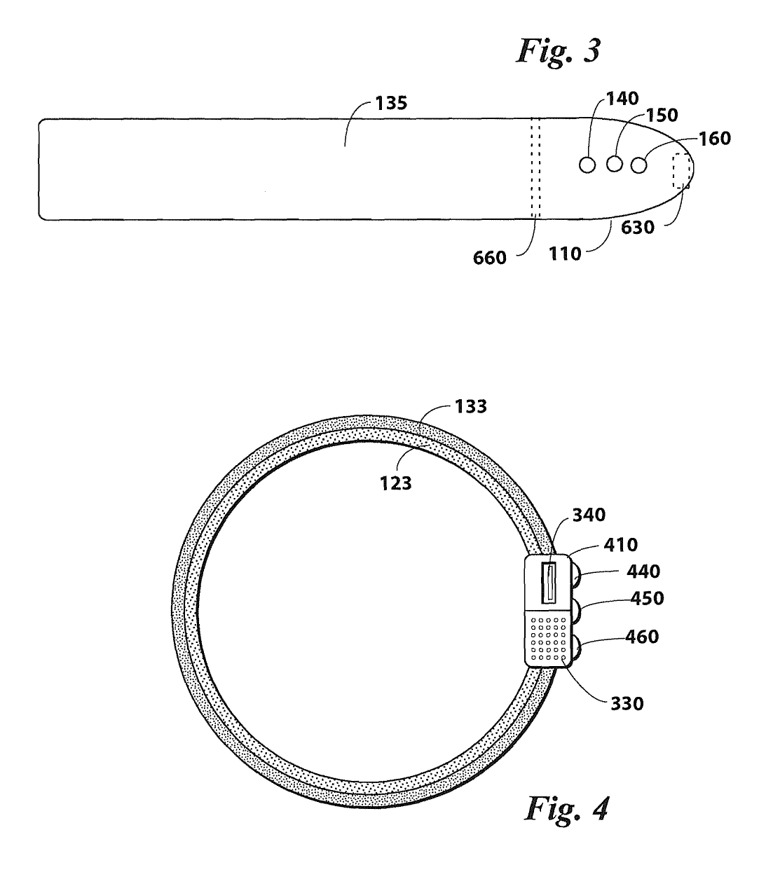

In some embodiments a touch-based control panel 110 might be used to receive input from the user. In that case, the control panel could be made to be an extension of the flexible displays (e.g., FIGS. 3 and 6A). The control information from the user would then be passed to one or more microprocessors internal to the control panel 110. In some embodiments, the control panel will utilize one or more hardware buttons/switches to allow a user to select different options. In other embodiments, the control panel might be accessed via a remote computer such as an application running on an iPhone or Android cellular telephone that communicates wirelessly (e.g., via Bluetooth®, Wi-Fi, etc.) with the microprocessor in the control panel 110.

No matter how the control information is acquired, one function of the microprocessor(s) that reside in the control panel will be to utilize control information from the user to adapt information received from a remote computer (including information generated internally via software) according to those commands. The adaptation will involve translating information into video which is subsequently sent to the displays 120/130 (FIG. 2) for presentation to the user. That is, the microprocessor will be used to generate computer graphics (including, but not limited to, video, static or moving images, static or moving text, etc.) for presentation to a user via the displays 120/130. Note that the instant device will be able to display information (text, video, graphic images, etc.) that has been received from a remote computer, where “remote computer” should be broadly construed to include, among others, a desktop computer, a laptop computer, a table computer, a cellular telephone, or any other programmable device with electronic communication capabilities that can be configured to communicate (wirelessly or via wire) with the instant device. Additionally, in some cases the graphics/video might be internally generated (e.g., the time might be continuously or intermittently scrolled throughout the length of the display) but even in those cases the information (e.g., the computer program that displays the time) will have been acquired from a remote computer of some sort.

Additionally note that, for purposes of the instant disclosure, when the term “microprocessor” is used, that term should be broadly construed to include any programmable device (e.g., microcontroller, CPU, programmable gate array, etc.). Further, “microprocessor” should be understood to possibly include multiple programmable devices that cooperate together to control the displays and receive and process input from a user (e.g., a multicore processor, or separate hardware components which each have a separate function within the device).

Power for different embodiments of the device might be provided by a conventional watch-type lithium battery (e.g., a button battery) arrangement which is located, for example, within the control panel 110, or by a flexible/printed battery of the sort made by Imprint Energy™ of Alameda, Calif. or Samsung SDI™ which will be incorporated, by example, into the central core 145 that is discussed at greater length below.

FIG. 2 illustrates in greater detail some components of an embodiment. In this embodiment, the control panel 110 will be running software which has been customized for this particular device 100. As can be seen, in this embodiment both of the displays will be protected by transparent or translucent shields 125/135 which might be made of any translucent or transparent substance that is flexible enough to bend with the display (e.g., plastic). In some embodiments, the shields 125/135 might be integral to, and manufactured in connection with, the displays 120/130. If the shields are integral thereto, it should be understood that the term “flexible display” includes both the display and its shield.

In some instances the flexible displays 120/130 will be touch sensitive (either pressure or capacitive) and choice of the shield material may need to be made in conjunction with the type of screen that is selected. In some embodiments, one or more lights 140 might be provided on the control panel 110 for purposes of illumination and/or for purposes of signaling the state of the device to a user (e.g., a light could be used to indicate that the device is powered “on” and/or serve as source of illumination if needed). FIG. 3 contains a plan view of the embodiment of FIG. 1 if it were to be unrolled. The latch object 630 is discussed in greater detail below.

Continuing with the embodiment of FIG. 2, in some cases the control panel 110 might house a digital camera 150 integral thereto. Additionally, and in certain embodiments, a mode button 160 will be provided to allow the user to communicate selection options to the microprocessor within the control panel 110. Such a button could be used to activate/deactivate the display device, change the type of display, activate/operate the camera, etc. In some embodiments, the instant device 100 might be equipped with a central core 145 which could provide support for the flexible displays that are intended to be presented to the user. Additionally, and in some embodiments, the central core 145 might contain a printed or other battery, electronic communications capabilities (as discussed below), etc.

In some embodiments a USB port 340 might be provided which could be used to charge the device, transfer programs, images, etc. to it, and retrieve data from t, etc. The USB port 340 might be situated on a side of the control panel 110 in FIG. 1 as is generally indicated in FIG. 4. Continuing with FIG. 4, a control panel 410 might be equipped with some number of buttons 440, 450, 460 to control its various functions. Alternatively, and as has been explained previously, some of the buttons in FIG. 4 might alternatively be devices (e.g., a camera, light, etc.).

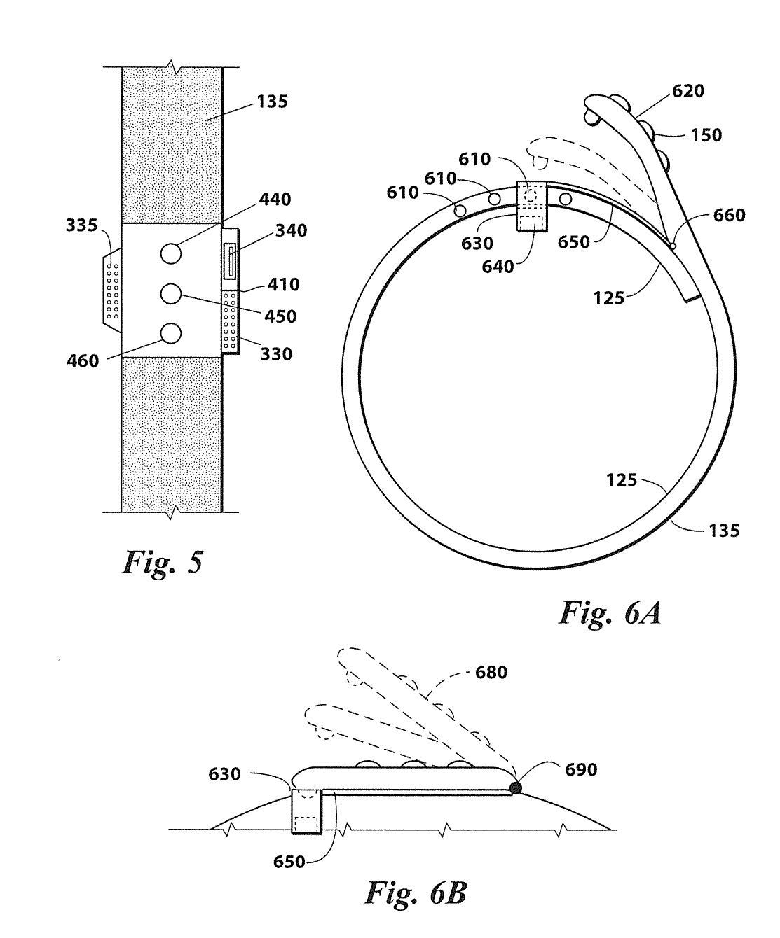

Some embodiments of the control panel 440 might come equipped with a microphone 330 so that the device could be used to record vocal presentations, music, and/or other sorts of audible information. (FIGS. 4 and 5). Some embodiments might include a small speaker 335 and/or an audio jack as well.

FIG. 5 contains a plan/outside view of the embodiment of FIG. 4. As is indicated, the camera 150, mic 330, speaker 335, and a USB port 340 will be accessible from the top/outside which would make these items readily accessible when the device is worn or otherwise in attached to the user. Also, placing these items on the edge of the device would limit their impact on the wearer, although placing them on the outer or inner surface of the device would be possible as well.

FIGS. 6A and 6B contain additional embodiments. In this case, a latch element 630 is provided to allow the user to adjust the size of the device. As can be seen, it is, in this embodiment, designed to mate with a number of indentations 610 which are on the edge of the device. Thus, by inserting the band 125 deeper into the latch element 630, it is possible to reduce the circumference of the display area. Additionally, it is contemplated there would be some sensing elements within the latch element 630 which would allow it to communicate to the control panel how much viewable display is present in the current configuration. Thus, the control panel will be able to make adjustments depending on the amount of displayable surface that is viewable along the exterior of the device 135. In some embodiments, a pin or other attaching mechanism might be used to loosen from then subsequently secure the latch element 630 to a new position on the band. Additionally, and in accordance with this embodiment, there is a latch plate 650 which extends from the latch element 630 to the band and is attached (preferably permanently) thereto at hinge point 660. Thus, the control panel 620 portion of the band can be lifted away from the latch element 630 which will unlock the device and permit the displayable portion of the band to be lengthened or shortened. In this embodiment, there might be no upraised buttons and, instead, a touch sensitive screen could emulate the function of the buttons.

Turning next to FIG. 6B, this figure illustrates still another embodiment of the invention where the control panel 680, instead of being a continuation of the band, is a discrete unit that is attached thereto. In this case, instead of being an extension of the band as illustrated in FIG. 6A, the control panel 680 will be a discrete/nondisplay hardware item that is connected to (or rests atop) the band and, in some embodiments, will be rotatable mounted 690 so it can be lifted or removed in order to adjust the length of the band.

FIG. 8 contains further information about an embodiment. In some cases, two cameras 630 and 810 will be provided that are oriented away from both the inner and outer surfaces, respectively. Such might be useful if the instant device were unwound and used to take a self-photo (“selfie”), engage in a videoconference, etc. In the embodiment of FIG. 8, the camera 810 is oriented such that its lens points down (outward from the band) so that its lens and that of the camera 630 point in opposite directions when the device is unrolled.

FIG. 8 additionally contains an example of an embodiment which provides a number of ports 820 about its side. In some embodiments, each one of those will contain electrical contacts which provide communication, e.g., through the central core 145 with the CPU and the control panel 620. According to an embodiment in FIG. 8, it would possible to attach various devices to the instant band and allow those devices to communicate their presence and function to the control panel 620. Additionally, this will also enable communication from the control panel 620 to the attached device via the port 820 in the event that control signals need to be transmitted to that device. As a specific example, the camera 810 once attached to the band through a port 820, will be able its status and image data to the control panel 620 and receive control information back therefrom.

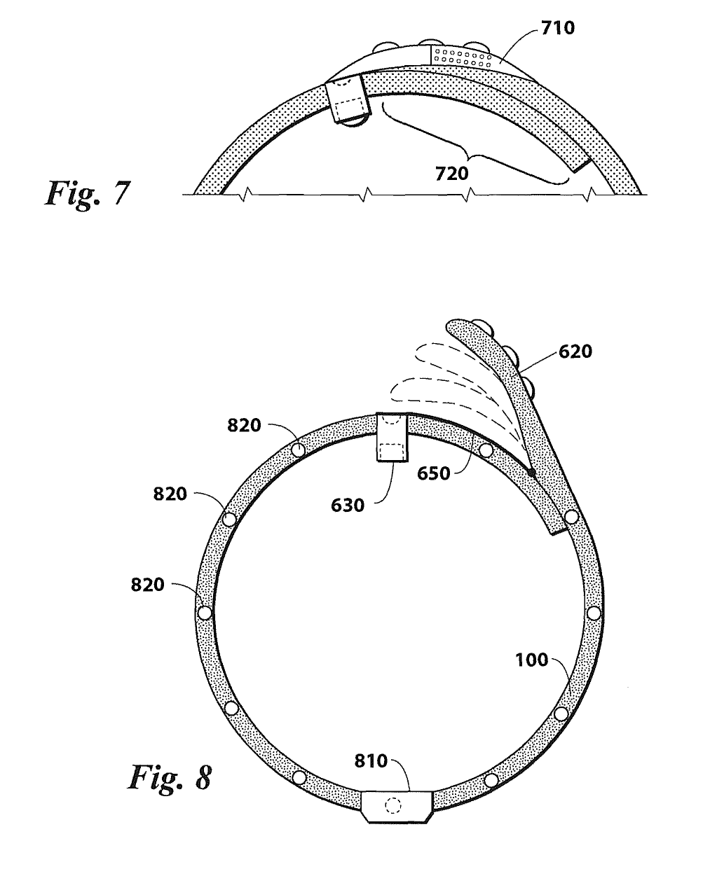

FIG. 7 contains additional details of an embodiment. As can be seen, the control panel 710 is a separate element that is designed to set atop the display and blend smoothly into it. As has been explained previously, the control panel 710 might contain some number of buttons and/or devices which can be manipulated or used by the user.

In some embodiments some amount of overlap in the ends of the instant invention might be desirable. For example, this might be the case when the instant device is configured as a bracelet and needs to be shortened to accommodate a smaller wrist. In such a case, the amount of overlap will be sensed by the device and only as much of the display that is visible will be used in presenting content to the user. See FIGS. 6A and 7.

According to this embodiment, the amount of display that is viewable on the outside of the instant device after it is fitted to its intended recipient would depend on the size of the wrist, arm, leg, neck, etc. In this embodiment, excess screen 720 will be tucked underneath the control panel 710 (FIG. 7), thereby making it adjustable to fit a wide variety of sizes. Additionally, in some embodiments the overlapped portion of the band 720 would not be used for display and, instead, whatever content was needed to be displayed would be scaled to occupy only the visible portion of the band.

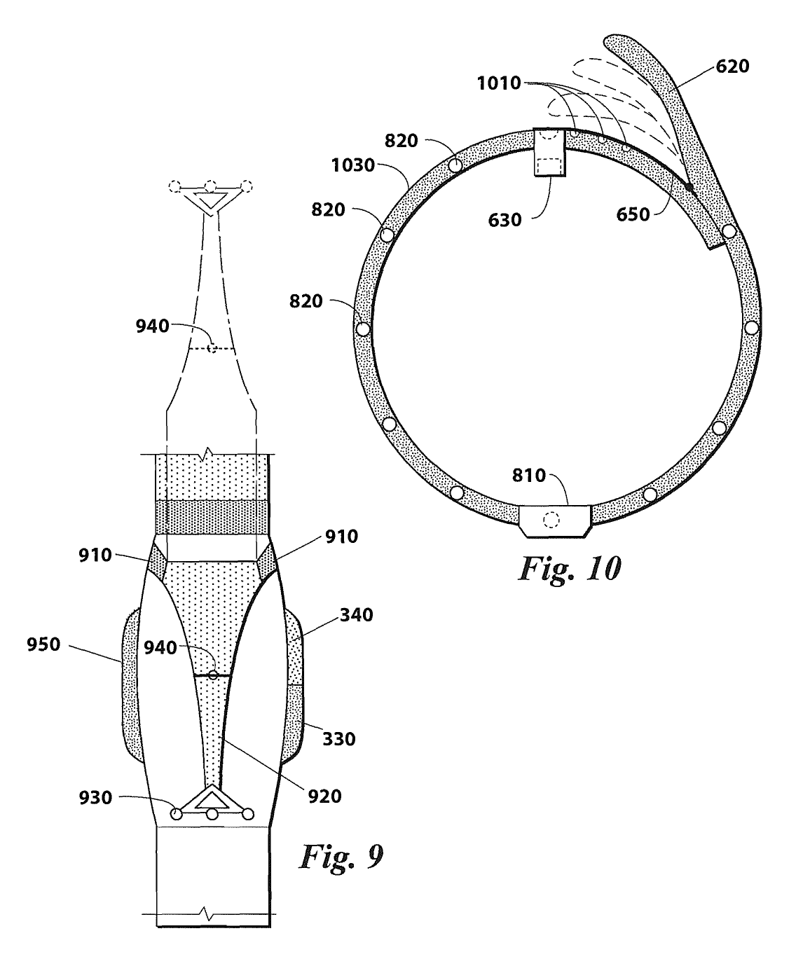

FIG. 9 contains an underside view of an embodiment which illustrates a kickstand-type prop suitable for use with this variation. As is indicated in this figure, when viewed from the underside of the control panel 950, the stand 920 is designed to be rotatably attached to the control panel 950 (e.g., via hinges 910) and extended to prop up the device in a vertical position when it is not warn and it is desirable to have both sides of the band viewable simultaneously (e.g., by two different users that are seated across from each other). As can be seen, the stand 920 will terminate in this embodiment in one or more a balls or knobs 930 that are designed to mate with corresponding dimples in the underside of the band, thereby making it possible to be stored and lay flush when this embodiment is worn.

Thus, if the user should decide to view the entirety of one of the screens of the instant device, the device can be unrolled and the stand 920 extended to allow the instant device to set up on its edge where both sides of it can be viewed simultaneously. In some embodiments a ball and socket joint 940 will be provided so that the stand 920 can be folded on itself for storage and/or unfolded to create a prop to hold up the device when it is desired to view both sides of the band simultaneously.

Turning again to FIG. 10, this variation contains additional details of an embodiment. According to this variation, a second camera 810 has been added to the band at a point distant from that of the control panel 620. Of course, such an arrangement would impact the viewing area of the outside of the bendable screen 1030 but software could certainly take this break in the continuous display surface 1030 so that any information that is intended to be presented to the user could be viewed in its entirety. For example, if a design or pattern is scrolled along the length of the display 1030, the software that controls the display could readily scroll around or past any break in the viewable area of the device. Additionally, indentations 1010 within latch plate 650 could be provided to mate with corresponding protuberances on the underside of the control panel 620 to retain in a closed position until it needed to be opened. Note that the latch plate 650 might be curved (to match the surface on which it is mounted) or made to be flexible to conform to that surface after it is place. It also might be made of a transparent material so that the video information that is being displayed under it can be readily viewed.

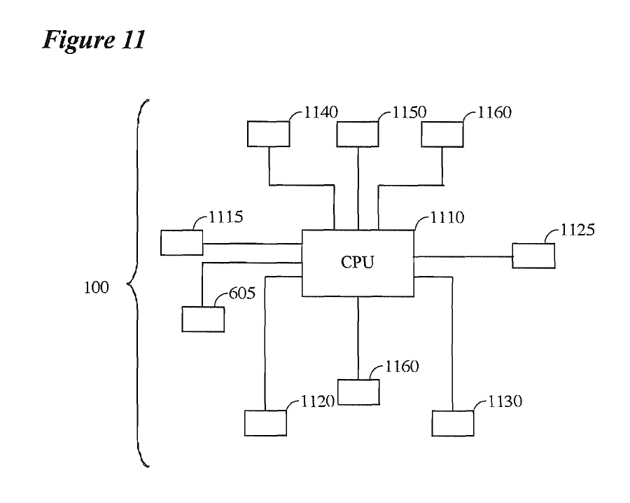

Turning next to FIG. 11, which contains a simple schematic of an embodiment, according to this embodiment, there is provided a microprocessor (“CPU”) 1110 which would conveniently be situated in some embodiments within the control panel (110). The CPU 1110 might be a single processor, a processor with multiple cores, multiple interconnected processors, etc. Those of ordinary skill in the art will readily be able to devise a microprocessor that will be suitable for use with the instant invention. The CPU would additionally be accompanied with some amount of memory (not shown) which might be used to hold programming instructions, video RAM information, general storage, etc. Among the functions of the CPU 1110 are to accept input from the user via mode button 1140, obtain images from cameras 1150/1160, record audio input from microphone 1115, read input from USB port 1125, and create video information for display on screens 1120/1130, which are situated back to back, as is generally indicated in, for example, FIG. 2. Additionally, and not shown, might be one or more antennas for receipt of Bluetooth®, Wi-Fi, and/or cellular wireless communications, including any future developed or unmentioned wireless technology.

In operation, the CPU 1110 would sense, for example, whether or not the instant invention 100 was being worn, in which case one of the screens 1120/1130 would not be visible. Among the ways that such might be sensed would include methods that utilize a contact or other sensor within clasp element 605 which will preferably be in electronic communication with the CPU 1110. Thus, when the instant invention 100 is being worn, there would be no need for the inner screen 120 to be activated and showing images. That being said, this would be a design decision that could be left to the sound judgment of a person of ordinary skill in the art. Additionally, in some instances, the camera 630 could be used to inform the CPU 1110 that the instant device is being worn which might be indicated, for example, by the absence of light being sensed by the camera 630.

Another function that, in some embodiments, might be handled by the CPU 1110 would be to monitor the connection ports 820 on the band to see whether an accessory device has been positioned there. For example, according to the embodiment of FIG. 8, a camera 810 might be positioned somewhere on the device 100. In some embodiments, the location will not be predetermined by the manufacturer but, instead, might be selected by the user. In that case, the user might be allowed to slide the device 810 along the length of the band 100, with it potentially being attachable at various of the accessory ports 820. If the CPU 1110 senses the presences of a device on one of the accessory points 820, it will then determine the particular location on the band, the type of device positioned there, and the sort of data that might be provided by such device. As an example, if a camera is positioned at accessory point 820, the CPU 1110 would know that fact by virtue of a signal transmitted from the camera 810 via accessory point 820. Upon receipt of that signal, the CPU 1110 would then expect image data to be transmitted from the camera 810 to the CPU 1110. Additionally, in some embodiments, buttons on the control panel 220 might be used to initiate the camera function of the remotely situated camera 810. Those of ordinary skill in the art will understand the sorts of software and hardware interconnections that would be necessary in order to make this possible.

In some embodiments, when the instant device is unrolled, both screens might be activated simultaneously. In that example, it would be possible to allow two users to watch the same video being displayed on their respective screens 120/130 and/or they might instead decide to watch different videos.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed or limited to there being one of that element unless the context specifically indicates otherwise.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners□of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

While this invention is susceptible of embodiment in many different forms, there is shown in the drawings, and is herein described in detail, some specific embodiments. It should be understood, however, that the present disclosure is to be considered an exemplification of the principles of the invention and is not intended to limit it to the specific embodiments or algorithms so described. Those of ordinary skill in the art will be able to make various changes and further modifications, apart from those shown or suggested herein, without departing from the spirit of the inventive concept, the scope of which is to be determined by the following claims.

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Additional aspects of the instant invention may be disclosed in one or more appendices hereto. Applicants hereby incorporate by reference into this disclosure the contents of any and all of such appendices, as if fully set out at this point.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A dual screen device, comprising:
a. a control panel, said control panel containing a microprocessor therein, said microprocessor being positionable to be in electronic communication with a remote computer and to receive information therefrom;
b. a flexible band attachable to said control panel, said flexible band having an inner surface and an outer surface, said flexible band being bendable to form a closed circle,
(i) wherein said inner surface comprises a first flexible display and said outer surface comprise a second flexible display,
(ii) wherein said first and second flexible displays are in electronic communication with said microprocessor and capable of displaying information received by the microprocessor thereon.

2. The dual screen device according to claim 1, wherein said control panel further comprises at least one of a USB port, a Bluetooth® communications module, a Wi-Fi communications module, a microphone, a speaker, a camera, and a mode button.

3. The dual screen device according to claim 1, wherein said electronic communication is wireless electronic communication.

4. The dual screen device according to claim 1, wherein said flexible band further comprises a central core situated between said first flexible display and said second flexible display.

5. The dual screen device according to claim 4, wherein said central core further comprises at least one accessory port, each of said at least one accessory ports being in electronic communication with said microprocessor.

6. The dual screen device according to claim 4, wherein said duel screen device further comprises an accessory camera removably attached to said dual screen device at one of said at least one accessory ports.

7. The dual screen device according to claim 1, wherein said remote computer is at least one of a desktop computer, a laptop computer, a tablet computer, and, a cellular telephone.

8. The dual screen device according to claim 1, wherein said dual screen device is sized to be around one of wrist, an ankle, a waist, and a neck.

9. The dual screen device according to claim 1, wherein said received information comprises at least one of a text message, a video file, and a graphic image.

10. The dual screen device according to claim 1, wherein said first and second flexible displays are both OLED displays.

11. The dual screen device according to claim 1, wherein said dual screen device is wearable.

12. A wearable dual screen device, comprising:
a. a control panel, said control panel containing a microprocessor therein, said microprocessor being positionable to be in electronic communication with a remote computer and to receive information therefrom;
b. a first flexible display having a first display outer surface and a first display inner surface, said first display being in electronic communication with said microprocessor and being adaptable to display on said first display outer surface said information therefrom, wherein said first display is bendable to form a closed circle and sized to be wearable by a user;
c. a second flexible display having a second display surface, said second display being in electronic communication with said microprocessor and being adaptable to display said information therefrom, said second display is bendable to form a closed circle and sized to be wearable by a user, wherein said first and second flexible display are incorporated into said wearable duel screen device such that said first display outer surface and said second display outer surface are both visible when said dual screen device is not worn.

13. The wearable dual screen device according to claim 12, wherein said control panel further comprises at least one of a USB port, a Bluetooth communications module, a Wi-Fi communications module, a microphone, a speaker, a camera, and a mode button.

14. The wearable dual screen device according to claim 12, wherein said electronic communication is wireless electronic communication.

15. The wearable dual screen device according to claim 12, further comprising a central core situated between said first flexible display and said second flexible display.

16. The wearable dual screen device according to claim 15, wherein said central core further comprises at least one accessory port, each of said at least one accessory ports being in electronic communication with said microprocessor.

17. The wearable dual screen device according to claim 16, wherein said wearable duel screen device further comprises an accessory camera removably attached to said wearable dual screen device at one of said at least one accessory ports.

18. The wearable dual screen device according to claim 12, wherein said remote computer is at least one of a desktop computer, a laptop computer, a tablet computer, and, a cellular telephone.

19. The wearable dual screen device according to claim 12, wherein said wearable dual screen device is sized to be wearable around one of wrist, an ankle, a waist, and a neck.

20. The wearable dual screen device according to claim 12, wherein said received information comprises at least one of a text message, a video file, and a graphic image.

21. The wearable dual screen device according to claim 12, wherein said first and second flexible displays are both OLED displays.
